(19) United States
(12) Patent Application Publication
(10) Pub. No.: US 2021/0373888 A1
(43) Pub. Date: Dec. 2, 2021

(54) MULTI-OBJECTIVE OPTIMIZATION METHOD AND SYSTEM FOR MASTER PRODUCTION PLAN OF CASTING PARALLEL WORKSHOPS

(71) Applicant: HUAZHONG UNIVERSITY OF SCIENCE AND TECHNOLOGY, Hubei (CN)

(72) Inventors: Xiaoyuan JI, Hubei (CN); Jianxin ZHOU, Hubei (CN); Yajun YIN, Hubei (CN); Hailong LI, Hubei (CN); Shiyu ZHANG, Hubei (CN); Xu SHEN, Hubei (CN)

(73) Assignee: HUAZHONG UNIVERSITY OF SCIENCE AND TECHNOLOGY, Hubei (CN)

(21) Appl. No.: 17/281,991

(22) PCT Filed: Jul. 29, 2020
(86) PCT No.: PCT/CN2020/105478

§ 371 Date: Apr. 1, 2021

(30) Foreign Application Priority Data
Aug. 29, 2019 (CN) 201910810210.X

(51) Int. Cl. G06F 9/30; G06N 3/12; G06F 9/445; G06F 9/38

(52) U.S. Cl. CPC G06F 9/30036; G06N 3/126; G06F 9/3836; G06F 9/30145; G06F 9/44505

(57) ABSTRACT

A multi-objective optimization method and system for a master production plan of casting parallel workshops belonging to a casting, producing, and scheduling fields are provided. In the method and the system, discrete coding is adopted, and parallel scheduling information is directly converted into discrete particles. Through crossing and mutation of each particle together with non-dominated particles in a global optimal solution set and individual optimal solution sets, a quick search of a solution space is completed. Congestion distances of non-dominated individuals in the solution space are calculated, sorting is performed according to congestion, and a new population is generated to allow the solutions to be uniformly distributed. As such, optimization results continue to converge through a population iteration process, the particles in the solution space continue to approach the front of an optimal solution set, and global non-dominated solutions in a plurality of objective directions are finally obtained.

### BACKGROUND

### Technical field

The disclosure belongs a field of casting, producing, and scheduling, relates to a multi-objective optimization method and system for a master production plan of casting parallel workshops, and in particular, relates to a multi-objective discrete particle swarm algorithm for the master production plan of the casting parallel workshops.

### Description of Related Art

Master production plans are key links in the production decision-making process of casting enterprises. Nevertheless, the existing master production plans of group multi-workshop casting enterprises are manually formulated, and in this way, it is difficult to comprehensively take various factors, such as enterprise costs, production efficiency, and workshop load balance, into consideration. Further, problems, such as low production scheduling efficiency and absence of scientific manners and rationality, are existed as well. These problems may severely limit the development of the enterprises. In group casting enterprises, workshops with the same production capacity are called parallel workshops. The master production plan problem of the parallel workshops has caught the attention from both academia and industry for a long time. Such problem is actually a classic parallel machine scheduling problem, which is, a np-hard problem. At present, it is still not possible to obtain the optimal solution of the problem through accurate calculation.

In a typical casting master production planning process, each of the workshops are expected that the tasks assigned to be fair and reasonable. A production manager is made satisfying assignment decisions. That is, it is necessary to find an optimal plan for the master production plan of the parallel workshops to achieve a win-win situation between the overall profits of the group enterprises and the workload balance of the parallel workshops. Nevertheless, in the existing master production plans of the casting enterprises, it is difficult to comprehensively take various factors, such as enterprise costs, production efficiency, and workshop load balance, into consideration, and problems, such as low production scheduling efficiency and absence of scientific manners and rationality, are existed as well.

With the continuous improvement of the level of digitalization, informatization, and intelligence in the casting industry, a favorable environment for introduction of multi-objective swarm intelligent decision-making algorithms is provided for the casting enterprises. Different from the common single-objective algorithms, the classic multi-objective algorithms such as NSGA-II and SPEA2, selects a plurality of objective non-dominated individuals through the pareto principle, and finally provides a set of optimal solutions to a decision maker. Through this method, the multi-objective problems may be effectively solved. Nevertheless, problems, such as slow convergence speed and insufficient search capability in solving the parallel machine scheduling problems, may still be found.

The particle swarm optimization algorithm is an algorithm based on swarm search proposed by dr. Eberhart and dr. Kennedy in 1995 based on bird predation behaviors. In the particle swarm algorithm, the group behavior of birds is simulated, and the biologists' biological group model is utilized to optimize the objects. Due to the good performance of the particle swarm optimization algorithm exhibits in solving the single-objective problems, many researchers pay much attention to its application in multi-objective optimization. Nevertheless, no corresponding research on the multi-objective optimization problem of the master production plans of the casting parallel workshops is provided for reference at present.

### SUMMARY

According to the above problems and improvement requirements of the related art, the disclosure provides a multi-objective optimization method and system for a master production plan of casting parallel workshops. The disclosure converts order scheduling tasks into discrete particles through discrete coding. Through crossing and mutation of each particle together with non-dominated particles in a global optimal solution set and individual optimal solution sets, a quick search of a solution space is completed. Congestion distances of non-dominated individuals in the solution space are calculated, sorting is performed according to congestion, and a new population is generated. As such, optimization results continue to converge through a population iteration process, the particles in the solution space continue to approach a front of an optimal solution set, and global non-dominated solutions in a plurality of objective directions are finally obtained. Efficiency and scientific manners and rationality of production scheduling are therefore improved.

To realize the above purpose, according to one aspect of the disclosure, a multi-objective optimization method for a master production plan of casting parallel workshops is provided and includes the following steps.

In S1, randomly generate s particles, form an initial population, and determine a particle chromosome size of each particle according to a number of orders to be scheduled n and a number of candidate parallel workshops m. A particle chromosome is represented by a one-dimensional vector formed by integers 1 to n and m−1 workshop separators through a discrete integer coding manner. Each of the integers 1 to n represents a serial number of each of the orders. The m−1 workshop separators divide the one-dimensional vector into m segments, each segment represents one workshop, and a sequence of the orders in the corresponding segment represents a processing sequence in the corresponding workshop.

In S2, select non-dominated particles from the initial population, a global optimal solution set gbest is formed, and an individual optimal solution set pbest formed by each of the particles itself in the initial population is initialized.

In S3, perform a local search on each of the particles in the initial population, generate a new set of solutions, and update the pbest sets and the gbest set with the new solutions.

Among three objects: a currently to be searched particle in the initial population, a non-dominated particle randomly selected from the pbest sets, and a non-dominated particle randomly selected from the gbest set, one object is randomly selected for mutation operations and two objects are randomly selected for crossover operations in each search.

In S4, select non-dominated particles from a candidate set formed by all of the pbest sets updated in step S3, and calculate objective function fitness values thereof in a solution space. The objective function fitness values of the non-dominated particles are sorted from small to large. Congestion values of the non-dominated particles are calculated after sorting, and the congestion values are sorted from small to large. The non-dominated particles corresponding to the first s congestion values are finally selected to form a new population.

In S5, determine whether a predetermined number of iterations g is achieved, output the gbest set updated in S3 as a final global optimal solution set if yes is determined, and repeat steps S2 to S5 on the new population if no is determined.

Further, in step S2, the pbest set is established for each of the particles in the initial population for recording non-dominated solutions searched by the particle. The pbest set is formed by particle itself in the initial population in an initial state. The gbest set is formed by recording the non-dominated solutions searched by all of the particles in the population of the initial population, and the non-dominated solutions are selected from the initial population to initialize the gbest set through a pareto principle.

Further, configure a local search range w, a crossover probability p_{c}, and a mutation probability pₘ in step S3. one object among the three objects is randomly selected for the crossover operations and two objects are randomly selected for the mutation operations based on the configured crossover probability p_{c} and the mutation probability pₘ in each local search process. Numbers of the crossover operations and the mutation operations are both w in each local search process.

Further, in step S3, each mutation operation is to randomly select two gene exchange positions from an original chromosome vector of the selected object. The new solutions are obtained after mutation.

Each crossover operation is to treat one of the two selected objects as a father particle and the other one as a mother particle, two genes are randomly selected from a chromosome vector of the father particle as crossover points. The new solutions are generated by the crossover operations directly preserve the two crossover points and external genes thereof. Remaining genes in the new solutions are directly filled in according to a sequence of the remaining genes in a chromosome of the mother particle, and the new solutions are accordingly obtained.

Further, in step S3, w new solutions are generated through the w mutation operations and the w crossover operations for any current particle performing a local search under the search range w. One non-dominated particle is randomly selected in 2*w new solutions through the pareto principle to update the pbest set after the current particle performs the local search. The non-dominated particles and the gbest set are selected from a total of s*2*w new solutions after all of the particles perform one local search.

Further, the pbest sets after all of the particles are updated in S4 are added to form the candidate set of the new population, and the non-dominated solutions are selected from the candidate set. Congestion values of the particles in the solution space are calculated through an environmental selection strategy and are sorted from small to large, and first s individuals are finally selected to form the new population.

Further, the congestion value of each of the particles is equal to a sum of absolute values of differences in objective functions between the particle itself and the particles on left and right sides of the particle after the particles are sorted from small to large according to predetermined objective function fitness.

To realize the above purpose, the disclosure further provides a multi-objective optimization system for a master production plan of casting parallel workshops including a multi-objective optimization process module and a processor. The multi-objective optimization process module implements the multi-objective optimization method as described above when being executed by the processor.

In general, the above technical solutions provided by the disclosure have the following beneficial effects compared with the related art.

1. In the disclosure, discrete coding is adopted, and parallel scheduling information, such as orders, workshops, and processing sequences, is directly converted into discrete particles. Through crossing and mutation of each particle together with the non-dominated particles in the global optimal solution set and the individual optimal solution sets, a quick search of the solution space is completed. The congestion distances of the non-dominated individuals in the solution space are calculated, sorting is performed according to the congestion, and the new population is generated to allow the solutions to be uniformly distributed. As such, the optimization results continue to converge through the population iteration process, the particles in the solution space continue to approach the front of the optimal solution set, and the global non-dominated solutions in a plurality of objective directions are finally obtained. In this way, the problem of lack of comprehensive consideration of various factors, such as enterprise costs, production efficiency, and workshop load balance, found in the existing master production plans of the casting enterprises and the problems of low production scheduling efficiency and absence of scientific manners and rationality may all be effectively solved.

2. In the method provided by the disclosure, since the specific forms and types of the objective functions are particularly not limited, the enterprises may comprehensively take factors, such as enterprise costs, production efficiency, and workshop load balance, into consideration. The possible optimal solutions of the enterprises in a plurality of objective directions may be effectively analyzed through the solution results, effective guidance is provided for the casting enterprises to formulate the master production plans of the parallel workshops, and the management level of the master production plans of the group casting enterprises is therefore significantly improved.

### BRIEF DESCRIPTION OF THE DRAWINGS

FIG. 1 is a flow chart of a multi-objective optimization method for a master production plan of casting parallel workshops according to a preferred embodiment of the disclosure.

FIG. 2 is a schematic diagram of coding and decoding according to a preferred embodiment of the disclosure.

FIG. 3 is a schematic diagram of a mutation operation according to a preferred embodiment of the disclosure.

FIG. 4 is a schematic diagram of a crossover operation according to a preferred embodiment of the disclosure.

### DESCRIPTION OF THE EMBODIMENTS

To better illustrate the goal, technical solutions, and advantages of the disclosure, the following embodiments accompanied with drawings are provided so that the disclosure is further described in detail. It should be understood that the specific embodiments described herein serve to explain the disclosure merely and are not used to limit the disclosure. In addition, the technical features involved in the various embodiments of the disclosure described below can be combined with each other as long as the technical features do not conflict with each other.

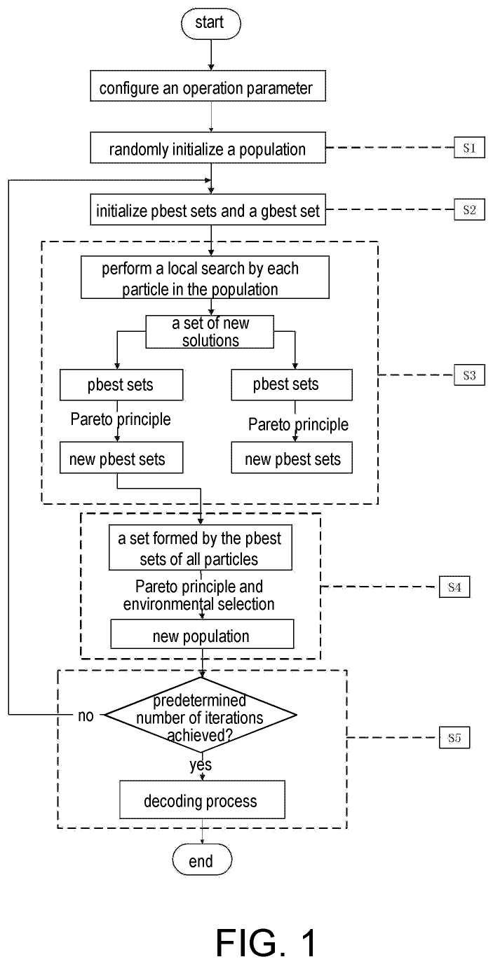

In this embodiment, a multi-objective discrete particle swarm algorithm parameter is configured, where a population size s=50, a maximum number of iterations g=80, a local search range w=3, a crossover probability p_{c}=0.8, and a mutation probability pₘ =0.2. The above values may be freely configured according to actual scheduling needs. For instance, when the particle population size and the local search range expand, accuracy of results increases, but calculation efficiency may accordingly decrease. Therefore, the above-mentioned specific values are only used to describe the disclosure in detail with examples and are not intended to specifically limit the disclosure. The main process steps of the disclosure are introduced as follows together with FIG. 1.

In S1, perform discrete integer coding on particles in an initial population.

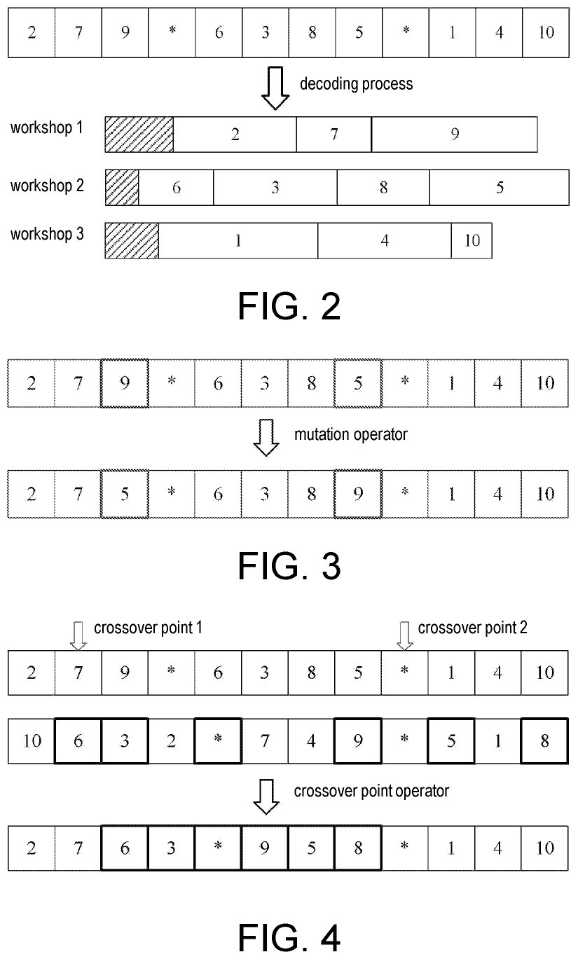

The initial population including 50 particles is randomly generated. In this embodiment, a number of orders is 10, a number of parallel workshops is 3, and a particle chromosome is represented by a one-dimensional vector formed by integers 1 to 10 and 2 asterisks. The numbers 1 to 10 represent 10 orders to be assigned, and 2 asterisks represent that the orders on both sides of the asterisks are divided into 3 parallel workshops. As shown in FIG. 2, coding of such particle chromosome means that: orders 2, 7, and 9 are assigned to a workshop 1, orders 6, 3, 8, and 5 are assigned to a workshop 2, and orders 1, 4, and 10 are assigned to a workshop 3. A sequence of serial numbers of the orders in the particle chromosome vector determines a sequence of operation of the workshops. After decoding, the orders are described by rectangles of different lengths according to production time of the orders. The shaded part of each of the workshops represents the remaining unfinished work in the workshop when the scheduling starts.

In step S2, initialize pbest sets and a gbest set.

An external set, the pbest set, is established for each of the particles, and each of the pbest sets is formed by the corresponding particle itself in an initial state. An external set, the gbest set, is established for the entire initial population, and a fitness value of an objective function of each of the particles in the initial population is calculated. In this case, two minimization objective functions f1 and f2, such as an enterprise cost objective and a production efficiency objective, are provided.

According to the pareto principle, for any two particles, namely particle a and particle b, if fitness function values f1(a) and f2(a) of the particle a are both greater than fitness function values f1(b) and f2(b) of the other particle b, then the particle a is dominated by the particle b. If a specific particle in the population is not dominated by any other particles, then a solution of such particle is a non-dominated solution. All of the non-dominated solutions in the initial population are used to initialize the gbest set.

In S3, perform a local search on each of the particles in the initial population, and generate a new set of solutions. To be specific, in the local search performed on each particle, a mutation operation is performed on one object randomly selected from three objects, namely the particle itself, one non-dominated particle randomly selected from the pbest sets, and one non-dominated particle randomly selected from the gbest set, or crossover operations are performed on two randomly-selected two objects. When the search range w=3, three mutation operations are performed to generate 3 new solutions, and at the same time, three crossover operations are performed to generate 3 new solutions. Preferably, the crossover operation or the mutation operation is performed on an object which is randomly selected each time in this embodiment. Next, 6 new solutions obtained through the local search are used to update the pbest sets and the gbest set through the pareto principle.

In the mutation operation, a new particle similar to the original particle is generated.

As shown in FIG. 3, in the case that 10 orders and 3 workshops are provided, two genes (“5” and “9” are selected in FIG. 3) are randomly selected from the original chromosome vector, and positions of the genes are exchanged to generate new particles after mutation.

In the crossover operation, a new particle that inherits gene characteristics of a father particle and a mother particle is generated. First, two crossover points are randomly selected from a chromosome vector of the father particle, and the new solutions generated by crossing preserve the two crossover points and external genes thereof. The remaining genes located between the two crossover points are rearranged according to a sequence corresponding to the remaining genes on a chromosome of the mother particle. FIG. 4 is a schematic diagram of the crossover operation of a particle having 10 orders and 3 workshops, and the genes from the father particle and the mother particle in the new particle chromosome are respectively represented by thin squares and thick squares. As shown in FIG. 4, the crossover points randomly selected from the father particle are “7” and two “*”. As such, “7”, the two “*″”, and external genes thereof, that is, “7”, the left side gene “2”, two “*”, and the right side genes “1”, “4”, and “10”, are all inherited to the new solutions. In the mother particle, after the genes “7”, “2”, the second “*”, “1”, “4”, and “10” are removed, the remaining genes “6”, “3”, the first “*”, “9”, “5”, and “8” are directly filled in a position between the crossover points “7” and the second “*” in the new solutions according to the sequence in the mother particle. A corresponding relationship of workshop separators “*” in the father particle and the mother particle is determined by a sequence of the “*”. For instance, in this embodiment, the second “*” in the mother particle corresponds to the second “*” in the father particle.

In particular, if a specific particle neither mutates nor crosses under the configured mutation probability and crossover probability, it may be understood that the new solution obtained after mutation and crossover is still the particle itself.

In S4: add the pbest sets of all of the particles in the population to form a candidate set of a new population, and select non-dominated solutions from the candidate set. Congestion values of the particles in a solution space are calculated through an environmental selection strategy and are sorted from small to large, and first s particle individuals are finally selected to act as the new population. The congestion values of the particles in the solution space are obtained through calculation performed on the non-dominated solutions. The fitness values of the non-dominated particles are calculated first and are sorted according to a fixed objective function sequence. If the current objective function fitness values are the same, the next objective function fitness values are calculated. For instance, regarding the particle a and the particle b, when optimization is performed on a multi-objective function, if the current objective function fitness values of the particle a and the particle b are the same, the next objective function fitness values are calculated until different values are obtained. If all of the objective function fitness values of the particle a and the particle b are the same, the values are sorted based on no particular sequence. In practice, basically, no objective functions of two particles are the same, and if the objective functions are the same, it may be that the “chromosomes” (i.e., scheduling plans) of the particles are completely the same. In this case, the sequence of sorting is not required to be taken into consideration.

The congestion value of each of the particles is equal to a sum of absolute values of differences in objective functions between the particles on the left and right sides of the particle. The congestion values are then sorted from small to large, and the first s=50 particles are finally selected to act as the new population. If particles having small congestion values are selected, the finally-outputted gbest set may exhibit a uniform solution distribution, and an optimal value of each of the objective functions may thus be reflected.

In S5, determine whether a predetermined number of iterations g=80 is achieved. The gbest set updated in S3 is outputted as a final global optimal solution set if yes is determined, and steps S2 to S5 are repeated if no is determined.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

1. A multi-objective optimization method for a master production plan of casting parallel workshops, characterized in that, wherein comprising:
S1: randomly generating S particles, forming an initial population, determining a particle chromosome size of each particle according to a number of orders to be scheduled N and a number of candidate parallel workshops M, wherein a particle chromosome is represented by a one-dimensional vector formed by integers 1 to N and M−1 workshop separators through a discrete integer coding manner, each of the integers 1 to N represents a serial number of each of the orders, the M−1 workshop separators divide the one-dimensional vector into M segments, each segment represents one workshop, and a sequence of the orders in the corresponding segment represents a processing sequence in the corresponding workshop;
S2: selecting non-dominated particles from the initial population, forming a global optimal solution set gbest, initiating an individual optimal solution set pbest formed by each of the particles itself in the initial population;
S3: performing a local search on each of the particles in the initial population, generating a new set of solutions, updating the pbest sets and the gbest set with the new solutions, wherein among three objects: a currently to be searched particle in the initial population, a non-dominated particle randomly selected from the pbest sets, and a non-dominated particle randomly selected from the gbest set, one object is randomly selected for mutation operations and two objects are randomly selected for crossover operations in each search;
S4: selecting non-dominated particles from a candidate set formed by all of the pbest sets updated in step S3, calculating objective function fitness values thereof in a solution space, sorting the objective function fitness values of the non-dominated particles from small to large, calculating congestion values of the non-dominated particles after sorting, sorting the congestion values from small to large, finally selecting the non-dominated particles corresponding to the first S congestion values to form a new population; and
S5: determining whether a predetermined number of iterations G is achieved, outputting the gbest set updated in S3 as a final global optimal solution set if yes is determined, repeating steps S2 to S5 on the new population if no is determined.

2. The multi-objective optimization method for the master production plan of the casting parallel workshops according to claim 1, wherein:
in step S2, the pbest set is established for each of the particles in the initial population for recording non-dominated solutions searched by the particle, the pbest set is formed by particles in the initial population in an initial state, the gbest set is formed by recording the non-dominated solutions searched by all of the particles in the population of the initial population, and the non-dominated solutions are selected from the initial population to initialize the gbest set through a Pareto principle.

3. The multi-objective optimization method for the master production plan of the casting parallel workshops according to claim 1, wherein:
a local search range W, a crossover probability P_{c}, and a mutation probability Pₘ are configured in step S3, one object among the three objects is randomly selected for the crossover operations and two objects are randomly selected for the mutation operations based on the configured crossover probability P_{c} and the mutation probability Pₘ in each local search process, and numbers of the crossover operations and the mutation operations are both W in each local search process.

4. The multi-objective optimization method for the master production plan of the casting parallel workshops according to claim 1, wherein:
in step S3, each mutation operation is to randomly select two gene exchange positions from an original chromosome vector of the selected object, the new solutions are obtained after mutation,
each crossover operation is to treat one of the two selected objects as a father particle and the other one as a mother particle, two genes are randomly selected from a chromosome vector of the father particle as crossover points, the new solutions generated by the crossover operations directly preserve the two crossover points and external genes thereof, remaining genes in the new solutions are directly filled in according to a sequence of the remaining genes in a chromosome vector of the mother particle, and the new solutions are accordingly obtained.

5. The multi-objective optimization method for the master production plan of the casting parallel workshops according to claim 4, wherein:
in step S3, W new solutions are generated through the W mutation operations and the W crossover operations for any current particle performing a local search under the search range W, one non-dominated particle is randomly selected in 2*W new solutions through the Pareto principle to update the pbest set after the current particle performs the local search, and the non-dominated particles and the gbest set are selected from a total of S*2*W new solutions after all of the particles perform one local search.

6. The multi-objective optimization method for the master production plan of the casting parallel workshops according to claim 4, wherein:
the pbest sets after all of the particles are updated in S4 are added to form the candidate set of the new population, the non-dominated solutions are selected from the candidate set, congestion values of the particles in the solution space are calculated through an environmental selection strategy and are sorted from small to large, and first S individuals are finally selected to form the new population.

7. The multi-objective optimization method for the master production plan of the casting parallel workshops according to claim 6, wherein:
the congestion value of each of the particles is equal to a sum of absolute values of differences in objective functions between the particle itself and the particles on left and right sides of the particle after the particles are sorted from small to large according to predetermined objective function fitness.

8. A multi-objective optimization system for a master production plan of casting parallel workshops, comprising a multi-objective optimization process module and a processor, wherein the multi-objective optimization process module implements the multi-objective optimization method according to claim 1 when being executed by the processor.

9. The multi-objective optimization method for the master production plan of the casting parallel workshops according to claim 2, wherein:
in step S3, each mutation operation is to randomly select two gene exchange positions from an original chromosome vector of the selected object, the new solutions are obtained after mutation,
each crossover operation is to treat one of the two selected objects as a father particle and the other one as a mother particle, two genes are randomly selected from a chromosome vector of the father particle as crossover points, the new solutions generated by the crossover operations directly preserve the two crossover points and external genes thereof, remaining genes in the new solutions are directly filled in according to a sequence of the remaining genes in a chromosome vector of the mother particle, and the new solutions are accordingly obtained.

10. The multi-objective optimization method for the master production plan of the casting parallel workshops according to claim 9, wherein:
in step S3, W new solutions are generated through the W mutation operations and the W crossover operations for any current particle performing a local search under the search range W, one non-dominated particle is randomly selected in 2*W new solutions through the Pareto principle to update the pbest set after the current particle performs the local search, and the non-dominated particles and the gbest set are selected from a total of S*2*W new solutions after all of the particles perform one local search.

11. The multi-objective optimization method for the master production plan of the casting parallel workshops according to claim 9, wherein:
the pbest sets after all of the particles are updated in S4 are added to form the candidate set of the new population, the non-dominated solutions are selected from the candidate set, congestion values of the particles in the solution space are calculated through an environmental selection strategy and are sorted from small to large, and first S individuals are finally selected to form the new population.

12. The multi-objective optimization method for the master production plan of the casting parallel workshops according to claim 11, wherein:
the congestion value of each of the particles is equal to a sum of absolute values of differences in objective functions between the particle itself and the particles on left and right sides of the particle after the particles are sorted from small to large according to predetermined objective function fitness.

13. The multi-objective optimization method for the master production plan of the casting parallel workshops according to claim 3, wherein:
in step S3, each mutation operation is to randomly select two gene exchange positions from an original chromosome vector of the selected object, the new solutions are obtained after mutation,
each crossover operation is to treat one of the two selected objects as a father particle and the other one as a mother particle, two genes are randomly selected from a chromosome vector of the father particle as crossover points, the new solutions generated by the crossover operations directly preserve the two crossover points and external genes thereof, remaining genes in the new solutions are directly filled in according to a sequence of the remaining genes in a chromosome vector of the mother particle, and the new solutions are accordingly obtained.

14. The multi-objective optimization method for the master production plan of the casting parallel workshops according to claim 13, wherein:
in step S3, W new solutions are generated through the W mutation operations and the W crossover operations for any current particle performing a local search under the search range W, one non-dominated particle is randomly selected in 2*W new solutions through the Pareto principle to update the pbest set after the current particle performs the local search, and the non-dominated particles and the gbest set are selected from a total of S*2*W new solutions after all of the particles perform one local search.

15. The multi-objective optimization method for the master production plan of the casting parallel workshops according to claim 13, wherein:
the pbest sets after all of the particles are updated in S4 are added to form the candidate set of the new population, the non-dominated solutions are selected from the candidate set, congestion values of the particles in the solution space are calculated through an environmental selection strategy and are sorted from small to large, and first S individuals are finally selected to form the new population.

16. The multi-objective optimization method for the master production plan of the casting parallel workshops according to claim 15, wherein:
the congestion value of each of the particles is equal to a sum of absolute values of differences in objective functions between the particle itself and the particles on left and right sides of the particle after the particles are sorted from small to large according to predetermined objective function fitness.

17. A multi-objective optimization system for a master production plan of casting parallel workshops, comprising a multi-objective optimization process module and a processor, wherein the multi-objective optimization process module implements the multi-objective optimization method according to claim 2 when being executed by the processor.

18. A multi-objective optimization system for a master production plan of casting parallel workshops, comprising a multi-objective optimization process module and a processor, wherein the multi-objective optimization process module implements the multi-objective optimization method according to claim 3 when being executed by the processor.

19. A multi-objective optimization system for a master production plan of casting parallel workshops, comprising a multi-objective optimization process module and a processor, wherein the multi-objective optimization process module implements the multi-objective optimization method according to claim 4 when being executed by the processor.

20. A multi-objective optimization system for a master production plan of casting parallel workshops, comprising a multi-objective optimization process module and a processor, wherein the multi-objective optimization process module implements the multi-objective optimization method according to claim 5 when being executed by the processor.
